(19) United States
(12) Patent Application Publication
(10) Pub. No.: US 2005/0061633 A1
(43) Pub. Date: Mar. 24, 2005

(54) Retaining ring for sprockets

(76) Inventor: Markus Bernhard Vetter, Schliengen (DE)

Correspondence Address: HODGSON RUSS LLP, ONE M & T PLAZA, SUITE 2000, BUFFALO, NY, 14203-2391, US

(21) Appl. No.: 10/647,836

(22) Filed: Aug. 25, 2003

(51) Int. Cl. B65G 23/06

(52) U.S. Cl. 198/834

(57) ABSTRACT

A retaining ring formed with a plurality of arms and an opening for sliding the ring over the shaft. The arms are formed with a convex shape such that elastic pressure is applied to the shaft. Also, the ends of the arms surrounding the opening have cooperating teeth capable of engaging to lock the ring around the shaft.

### FIELD OF INVENTION

The present invention relates to a conveying apparatus, and more particularly to a conveying apparatus having a conveyor belt driven by rotating drive members such as sprockets.

### BACKGROUND OF THE INVENTION

In applications where modular conveying belts are utilized, it is common practice to use driving and idling shafts equipped with a number of sprockets. The sprockets engage in the grid of the modular belt in order to drive and to guide the belt. Because modular plastic belts may vary with regard to dimension due to temperature variations and/or high forces, it is necessary to keep the sprockets movable on their shaft in order to allow them to adjust their position with the moving belt. However, it is also of interest to use the sprockets for tracking the belt so that side guides can be avoided. In order to provide tracking performance and at the same time to allow the sprockets to adjust their position, it is common practice to fix only one sprocket on each shaft and to let the other sprockets float along the shaft.

The fixing of the tracking sprocket has been accomplished in many different ways. For example, stop-plates may be attached to the shaft on opposite sides of the sprocket. Closed rings with sets screws have also been used. Retaining rings (i.e., circlips) may be engaged with grooves cut into the shaft. These systems have the disadvantage that they need to be shifted over the shaft for installation. This is particularly problematic if split sprockets are used, which are installed on the shaft already fixed to the conveyor frame. What is needed is an inexpensive sprocket retaining device that can be installed easily onto the shaft after all the sprockets are in place.

### SUMMARY OF THE INVENTION

The present invention meets the above-described need by providing a retaining ring formed with a plurality of arms and an opening for sliding the ring over the shaft. The arms are formed with a convex shape such that elastic pressure is applied to the shaft. Also, the ends of the arms surrounding the opening have cooperating teeth capable of engaging to lock the ring around the shaft.

### BRIEF DESCRIPTION OF THE DRAWINGS

The invention is illustrated in the drawings in which like reference characters designate the same or similar parts throughout the figures of which:

FIG. 1 is a perspective view of a shaft with prior art retaining plates disposed on opposite sides of a tracking sprocket;

FIG. 2 is a partial front elevational view of a prior art retaining ring with a set screw;

FIG. 3 is a side elevational view of the retaining ring shown in FIG. 2;

FIG. 4 is a front elevational view of the prior art retaining plate shown in FIG. 1;

FIG. 5 is a front elevational view of a prior art retaining ring;

FIG. 5a is a side elevational view of the retaining ring of FIG. 5;

FIG. 6a is a front elevational view of the retaining ring of the present invention;

FIG. 6b is a side elevational view of the retaining ring of FIG. 6a;

FIG. 7 is a side elevational view of the retaining ring of the present invention prior to insertion over the shaft;

FIG. 8 is a side elevational view of the retaining ring of the present invention during insertion over the shaft;

FIG. 9 is a side elevational view of the retaining ring of the present invention during the final stage of installation;

FIG. 10 is a side elevational view of the present invention installed on a shaft;

FIG. 11 is a side elevational view of a tracking sprocket and retaining ring of the present invention;

FIG. 12 is a front elevational view of a shaft, tracking sprocket, and retaining ring of the present invention, and,

FIG. 13 is a side elevational view of the retaining ring during disassembly.

### DETAILED DESCRIPTION

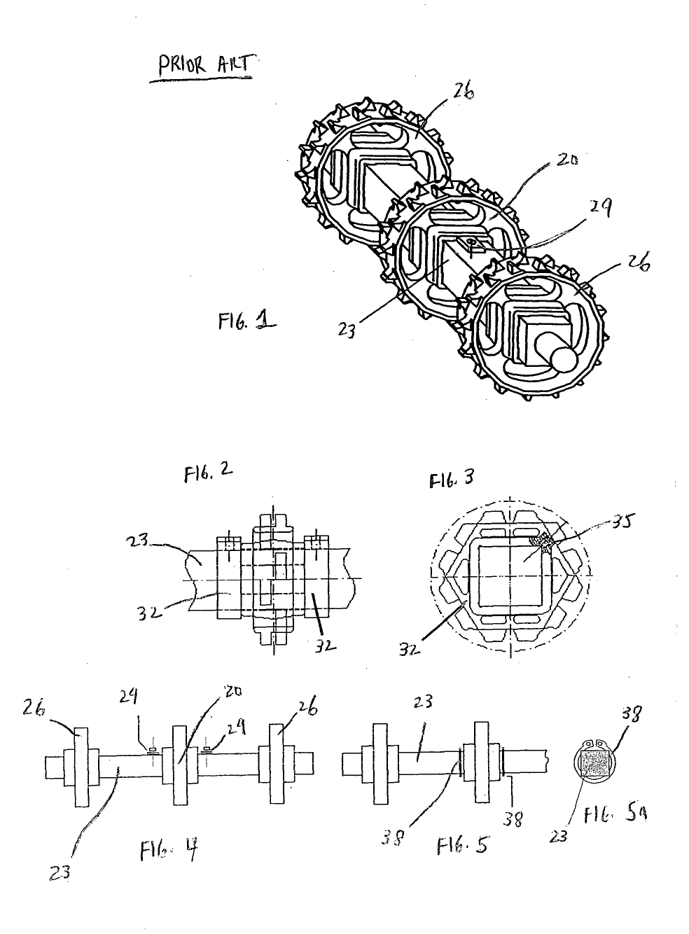

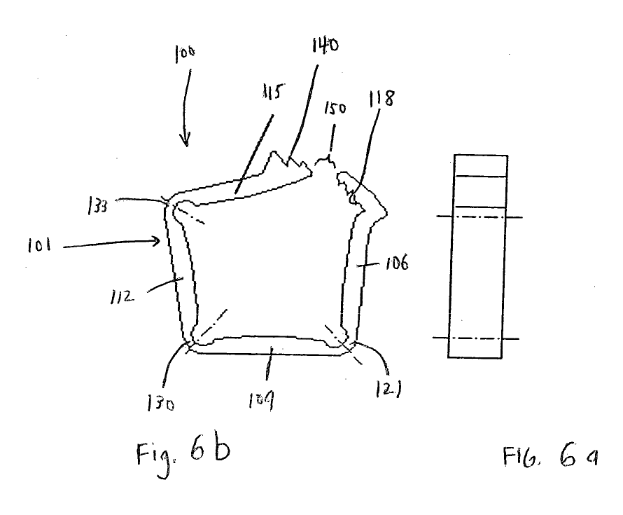

Referring to the prior art shown in FIGS. 1-5 and initially to FIGS. 1 and 4, it is common practice to fix only one sprocket 20 on the shaft 23 and to let the other sprockets 26 float. As will be evident to those of ordinary skill in the art, one prior art method for fixing the tracking sprocket 20 is to provide stop-plate 29 which is attached to the shaft on opposite sides of the sprocket 20.

As shown in FIGS. 2 and 3, another option is to provide retaining rings 32 with set screws 35.

Yet another alternative shown in FIGS. 4-5 is to provide retaining rings 38 disposed in grooves (not shown) in the shaft 23. For example, as will be evident to those of ordinary skill in the art, the retaining rings 38 may comprise circlips.

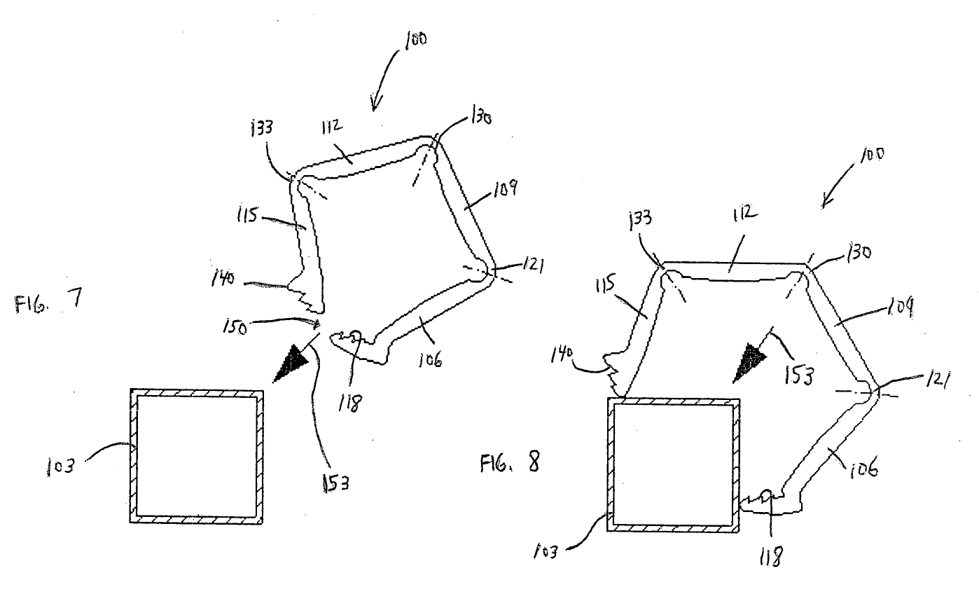

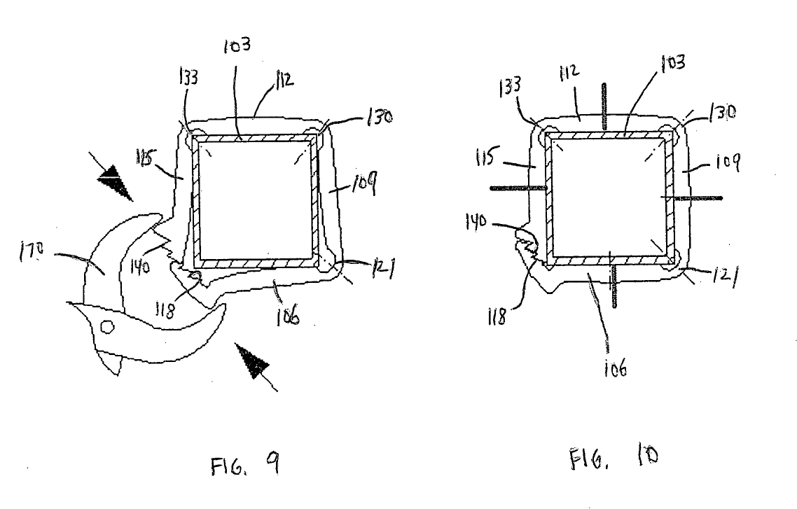

Turning to FIGS. 6a-6b, the retaining ring 100 of the present invention is shown as configured for use with a square shaft 103 (FIG. 7). The present invention is not limited to shafts having any specific shape, and the invention may be adapted for use with other shaft shapes as will be evident to those of ordinary skill. The ring 100 is molded from plastic material with high strength such as Polyamide or the like. The material can be fiber reinforced, and the part can be formed by other means such as machining.

The retaining ring 100 has a body 101 that may be formed with a plurality of arms 106, 109, 112, and 115. Arm 106 has a convex shape which in combination with the elastic properties of the material of construction provides a force against the shaft 103 as described in greater detail below. An engaging member comprising a set of teeth 118 is disposed at one end of the arm 106. At the opposite end of the arm 106, a curved section 121 extends to arm 109. The curved section 121 may comprise a reduced thickness region in comparison to the arms. The reduced thickness may provide for bending of the arms. Arm 109 extends substantially perpendicular to arm 106 and also has a convex shape that combines with the elasticity of the material to provide a force on the shaft 103. At the end of arm 109 opposite from arm 106, a curved section 130 extends to arm 112. Arm 112 also has a convex shape as described above in connection with arms 106 and 109. Arm 115 is connected to arm 112 by another curved section 133. Arm 115 has an engaging member comprising a set of teeth 140 disposed at a distal end. The teeth 140 are capable of interlocking with teeth 118. As will be evident to those of ordinary skill in the art, cooperating teeth are one example of interlocking mechanical engaging members. Other engaging members such as tongue and groove, hook and latch or the like may also be suitable.

An opening 150 is defined between the end of arms 106 and 115. The opening 150 provides the capability of inserting the retaining ring 100 over and onto the shaft 103 at different positions along the shaft 103.

Turning to FIGS. 7-8, the retaining ring 100 of the present invention can be inserted onto shaft 103 in the direction of arrow 153. The arms 106 and 115 are capable of spreading out as shown in FIG. 8 until the ring 100 fits over the shaft 103.

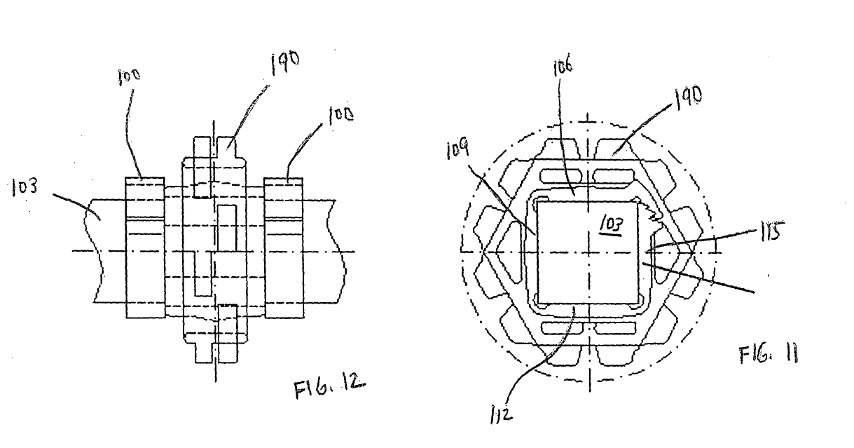

Turning to FIG. 9, once the arms 106 and 115 have been expanded until the ring 100 fits over the shaft 103, the resilient arms spring back and the teeth 118, 140 disposed at the ends of arms 106 and 115 are juxtaposed. As shown, a pair of pliers 170 can be used to engage the teeth 118, 140 on the ends of the arms. The teeth 118, 140 are capable of engaging such that the arms 106 and 115 lock together. As the force is applied, the surfaces of the teeth cam in the locking direction such that the teeth are capable of being easily engaged in a first direction toward each other, but resist being pulled in the opposite direction.

In addition to the engagement of the cooperating teeth 118, 140, the convex shape of the arms and the elasticity of the material of construction for the arms causes the ring 100 to apply a force to the shaft 103 to hold the ring 100 in the locked position shown in FIG. 10.

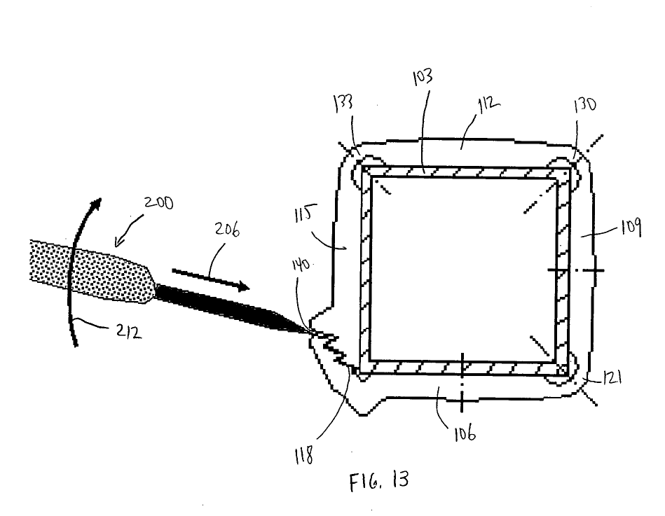

As shown in FIGS. 11 and 12, the retaining ring 100 of the present invention is disposed on opposite sides of a drive member such as tracking sprocket 190.

Turning to FIG. 13, the retaining ring 100 may be uninstalled by means of an ordinary flat head screwdriver 200. The blade 203 of the screwdriver 200 may be inserted between teeth 118, 140 in the direction of arrow 206. Next, the handle 209 of screwdriver 200 may be rotated in the direction of arrow 212 to pry the teeth 118, 140 open.

While the invention has been described in connection with certain embodiments, it is not intended to limit the scope of the invention to the particular forms set forth, but, on the contrary, it is intended to cover such alternatives, modifications, and equivalents as may be included within the spirit and scope of the invention as defined by the appended claims.

1. An apparatus for a belt-type conveyor, comprising:
a rotatable shaft;
a drive member mounted on the shaft for transmitting force between the shaft and a conveying belt; and,
a retaining ring mounted on the shaft adjacent to the drive member, the retaining ring having a resilient body terminating at first and second ends, the first and second ends spaced by a gap, the body capable of flexing such that the shaft fits through the gap when the ring is placed over the shaft, the first and second ends having cooperating engaging members capable of locking together when the ring is disposed over the shaft.

2. The apparatus of claim 1, wherein the body further comprises a plurality of arms.

3. The apparatus of claim 2, wherein the arms are convex-shaped.

4. The apparatus of claim 1, wherein the drive member is a sprocket.

5. The apparatus of claim 1 wherein the engaging members comprise cooperating teeth.

6. The apparatus of claim 2, wherein the arms are disposed such that adjacent arms are substantially perpendicular to one another.

7. The apparatus of claim 6, wherein adjacent arms are connected by arcuate sections.

8. The apparatus of claim 7, wherein the arcuate sections have a thickness that is smaller than the thickness of the arms.

9. An apparatus for a belt-type conveyor, comprising:
a rotatable shaft;
a sprocket mounted on the shaft for transmitting force between the shaft and a conveying belt; and,
a retaining ring mounted on the shaft adjacent to the sprocket, the retaining ring having a resilient body terminating at first and second ends, the body comprising a plurality of convex-shaped arms, the body capable of flexing such that the ring fits over the shaft, the first and second ends having cooperating engaging members capable of locking together when the ring is disposed over the shaft.

10. The apparatus of claim 9, wherein the engaging members comprise teeth.

11. The apparatus of claim 9, wherein the arms are disposed such that adjacent arms are disposed substantially perpendicular to each other.

12. The apparatus of claim 11, wherein adjacent arms are connected by an arcuate section.

13. The apparatus of claim 12, wherein the arcuate section has a thickness that is smaller than the thickness of the arms.

14. An apparatus for a belt-type conveyor, comprising:
a rotatable shaft;
a drive member mounted on the shaft for transmitting force between the shaft and a conveying belt; and,
a retaining ring mounted on the shaft adjacent to the drive member, the retaining ring having a resilient body with a plurality of convex-shaped arms having a first thickness, the plurality of arms being disposed in alternating fashion such that adjacent arms are substantially perpendicular to each other, the body terminating in first and second ends spaced by a gap, the plurality of arms being connected by arcuate sections having a second thickness that is smaller than the first thickness of the plurality of arms, the body capable of flexing such that the ring fits over the shaft, the first and second ends having cooperating engaging members capable of locking together when the ring is disposed over the shaft.

15. The apparatus of claim 14, wherein the drive member is a sprocket.

16. An apparatus for a belt-type conveyor, comprising:
a rotatable shaft;
means for transmitting force between the shaft and a conveying belt; and,
a retaining ring mounted on the shaft adjacent to the transmitting means, the retaining ring having a resilient body terminating at first and second ends spaced by a gap, the body capable of flexing such that the ring fits over the shaft, the first and second ends having cooperating engaging members capable of locking together when the ring is disposed over the shaft.

17. The apparatus of claim 16, wherein the body further comprises a plurality of arms.

18. The apparatus of claim 17, wherein the arms are convex-shaped.

19. The apparatus of claim 16, wherein the engaging members comprise teeth.

20. The apparatus of claim 17, wherein the arms are disposed such that adjacent arms are disposed perpendicular to each other.

21. The apparatus of claim 20, wherein adjacent arms are connected by an arcuate section.

22. The apparatus of claim 21, wherein the arcuate section has a thickness that is smaller than the thickness of the arms.
